(19) United States
(12) Patent Application Publication
(10) Pub. No.: US 2025/0381903 A1
(43) Pub. Date: Dec. 18, 2025

(54) Cup Holder Device

(71) Applicant: Steven Jennerich, Rutherford, NJ (US)

(72) Inventor: Steven Jennerich, Rutherford, NJ (US)

(21) Appl. No.: 19/062,543

(22) Filed: Feb. 25, 2025

Related U.S. Application Data
(60) Provisional application No. 63/660,732, filed on Jun. 17, 2024.

(51) Int. Cl. B60N 3/10

(52) U.S. Cl. CPC B60N 3/103

(57) ABSTRACT

A cup holder device is disclosed which comprises a body component that is configured in a cylindrical shape with a wide top opening in order to catch any spill or drip from a beverage. The interior of the body component is an absorbent material to ensure that every spill or drip is caught within the device. Further, the entire body component is completely disposable and environmentally friendly. Thus, the body component is small and can be disposed of after each use.

### CROSS-REFERENCE TO RELATED APPLICATION

The present application claims priority to, and the benefit of, U.S. Provisional Application No. 63/660,732, which was filed on Jun. 17, 2024, and is incorporated herein by reference in its entirety.

### FIELD OF THE INVENTION

The present invention relates generally to the field of cup holder devices. More specifically, the present invention relates to a cup holder insert for a car. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in cup holder devices. Generally, the cup holder of a vehicle often ends up wet and/or stained due to spills and drips from beverages, such as fountain drinks and coffee. Fountain drinks sweat and drip, while coffee, tea, and hot chocolate cups frequently overflow. Accordingly, the liquid not only creates wetness inside the cupholder, but can also cause staining and stickiness. Further, vehicle owners are forced to frequently clean the interior of the cup holders to keep the mess at bay. Similarly, insect infestations can occur if drink spills are left to fester.

Accordingly, a cup holder insert constructed in accordance with the invention can be easily placed within a vehicle's cup holder. Further, it is often necessary for people to prevent any spillage or liquid within their cup holders. This can create a mess and even severely damage a car's interior. Accordingly, people typically do not carry anything in their vehicle to clean up the mess that the drink in the cup holder is creating and so just leave it.

Accordingly, there is a demand for an improved cup holder device that allows users to protect their vehicle from stains or spills. More particularly, there is a demand for a cup holder device that users can keep in their vehicle and dispose of with case.

Therefore, there exists a long felt need in the art for a cup holder device that provides an absorbent insert for a cup holder to prevent spills and drips from beverages, such as fountain drinks and coffee. There is also a long felt need in the art for a cup holder device that keeps the cup holder of a vehicle clean and dry and free of condensation and moisture, which may cause mold. Further, there is a long felt need in the art for a cup holder device that includes a wide opening at the top to make it easy to place any beverage cup inside without incident. Moreover, there is a long felt need in the art for a device that contains spills and drips to help maintain the cleanliness of the vehicle and reduce the need for frequent cleanups. Further, there is a long felt need in the art for a cup holder device that protects the vehicle interior from sticky or staining liquids to preserve the vehicle's condition and value including electronic components in or near the vehicle's console. Finally, there is a long felt need in the art for a cup holder device that reduces the chance of insect infestations from sugary drinks that were spilled that people may not know about.

The subject matter disclosed and claimed herein, in one embodiment thereof, comprises a cup holder device. The device is a modified cup holder insert to collect spills or drips within a vehicle. The cup holder device comprises a body component that is configured in a cylindrical shape with a wide top opening. The interior of the body component is an absorbent material to ensure that every spill or drip is caught within the device. Further, the entire body component is completely disposable and environmentally friendly. Thus, the body component is small and can be disposed of after each use. An optional storage container can be added for additional storing options within the vehicle.

In this manner, the cup holder handle device of the present invention accomplishes all of the forgoing objectives and provides users with a device that provides a cup holder insert. The device is an absorbent insert to protect vehicles from messes caused by drinks placed in cup holders. The device can comprise a storage container and is completely disposable.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cup holder device. The device is a modified cup holder insert where the insert is absorbent and disposable. The cup holder device comprises a body component that can be placed within a traditional cup holder within a vehicle. Further, the device has a wide top opening to allow for all sizes of beverages to fit inside. Thus, the body component is relatively small, portable, and absorbent.

In one embodiment, the cup holder device allows users to have a beverage in their vehicle's cup holder without ruining the vehicle. Further, the absorbent interior lining allows for any spills or drips to be caught before they can ruin a vehicle. Accordingly, users can dispose of the cup holder device after use, saving them from having to clean out their cup holders.

In one embodiment, the cup holder device comprises a body component that is configured in a cylindrical shape. The body component comprises an exterior surface, an absorbent interior surface, and a wide open top. However, the body component can be any suitable shape and size as is known in the art, as long as the body component is sized and shaped to fit within a vehicle's cup holder.

In one embodiment, the body component comprises a wide top opening. This wide top opening is circular and allows the body component to have a sort of lip at the top of it. This wide top opening can fit any-sized beverage that would also comfortably fit within a vehicle's cup holder. Further, it is shallower than the inside cavity of the body component to allow for any spills coming from the top of a beverage to be caught before splashing anywhere else in the car.

In one embodiment, the absorbent interior lining completely coats the interior of the body component. This absorbent interior lining allows for any kind of liquid to cither spill or drip from a beverage to not reach the actual interior of the car. This absorbent interior lining is comprised of a synthetic polymer material which can easily soak up liquid and stop it from spreading or splashing. This lines the entire interior surface of the body component, including the wide open top.

In one embodiment, the body component is completely disposable and environmentally friendly. In this way, the body component can be thrown out after use and replaced to ensure that it is fresh every time it is in the car. This prevents bacteria growth as well as provides a better aesthetic for the car. The device can be recycled and cleaned instead of disposed of, which provides a more environmentally friendly alternative.

In yet another embodiment, the cup holder device comprises a plurality of indicia.

In yet another embodiment, a method of protecting the interior of a vehicle from spills is disclosed. The method includes the steps of providing a cup holder device comprising a body component with a wide open top and absorbent interior lining. Further, the method comprises fitting the body component within the cupholder inside the vehicle. The method also comprises placing the beverage within the body component. Finally, the method comprises disposing of the device once the beverage is removed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the cup holder device of the present invention showing the device in different colors in accordance with the disclosed architecture;

FIG. 2 illustrates a perspective view of one embodiment of the cup holder device of the present invention showing the wide open top in accordance with the disclosed architecture;

FIG. 3 illustrates a perspective view of one embodiment of the cup holder device of the present invention showing the device in use to insert a cup in accordance with the disclosed architecture;

FIG. 4 illustrates a perspective view of one embodiment of the cup holder device of the present invention showing the device in use to absorb drips in accordance with the disclosed architecture;

FIG. 5 illustrates a perspective view of one embodiment of the cup holder device of the present invention showing the body component in place in a vehicle in accordance with the disclosed architecture; and

FIG. 6 illustrates a flowchart showing the method of protecting your vehicle from spills in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a cup holder device that provides an absorbent insert for a cup holder to prevent spills and drips from beverages, such as fountain drinks and coffee. There is also a long felt need in the art for a cup holder device that keeps the cup holder of a vehicle clean and dry and free of condensation and moisture. Further, there is a long felt need in the art for a cup holder device that includes a wide opening at the top to make it easy to place any beverage cup inside without incident. Moreover, there is a long felt need in the art for a device that contains spills and drips to help maintain the cleanliness of the vehicle and reduce the need for frequent cleanups. Further, there is a long felt need in the art for a cup holder device that protects the vehicle interior from sticky or staining liquids to preserve the vehicle's condition and value. Finally, there is a long felt need in the art for a cup holder device that reduces the chance of insect infestations from sugary drinks that were spilled that people may not know about.

The present invention, in one exemplary embodiment, is a novel cup holder device. The cup holder device comprises a body component that is configured in a cylindrical shape with a wide top opening. The interior of the body component is an absorbent material to ensure that every spill or drip is caught within the device. Further, the entire body component is completely disposable and environmentally friendly. Thus, the body component is small and can be disposed of after each use. The present invention also includes a novel method of protecting a vehicle from spills. The method includes the steps of providing a cup holder device comprising a body component with a wide open top and absorbent interior lining. Further, the method comprises fitting the body component within the cupholder inside the vehicle. The method also comprises placing the beverage within the body component. Finally, the method comprises disposing of the device once the beverage is removed.

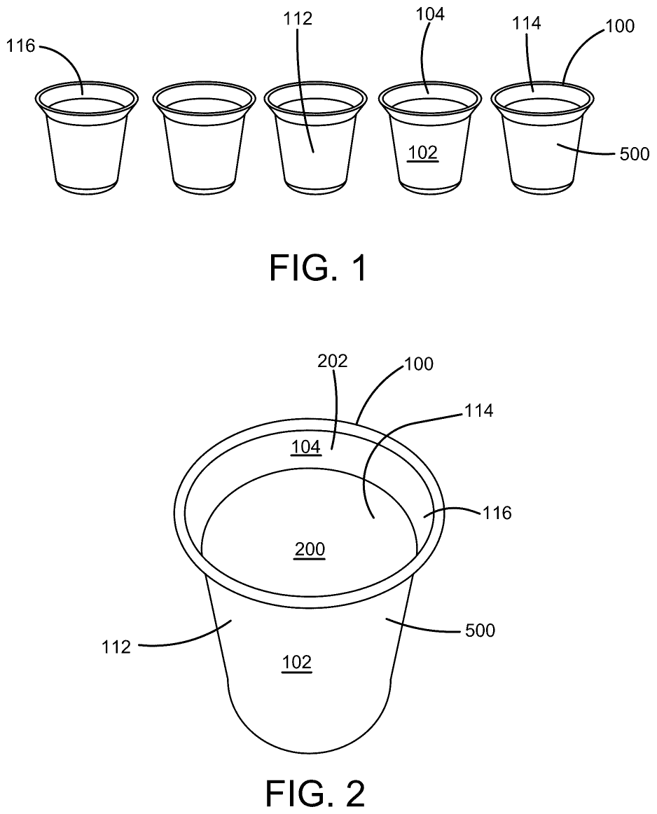

Referring initially to the drawings, FIG. 1 illustrates a perspective view of one embodiment of the cup holder device 100 of the present invention. In the present embodiment, the cup holder device 100 is an improved cup holder device 100 that provides a user 106 with a disposable cup holder insert. Specifically, the cup holder device 100 comprises a body component 102 with an absorbent interior lining 104. Thus, the body component 102 is relatively small, disposable, and absorbent via the absorbent interior lining 104. The body component 102 is easily stackable, as well, and can be sold in a stack or sleeve.

Generally, the cup holder device 100 allows users 106 to use the cup holder 118 within their vehicle 108 without worrying about damaging the inside of their vehicle 108, especially any electronic components on the center console. Further, the cup holder device 100 can be completely disposed of and is environmentally friendly. Accordingly, users 106 can place their beverages 110 within the device 100 saving their vehicle 108 from any messiness from spills or drips.

Further, the cup holder device 100 comprises a body component 102 that is configured in a cylindrical shape. The body component 102 comprises an exterior surface 112, an absorbent interior surface 114, and a wide open top 116. However, the body component 102 can be any suitable shape and size as is known in the art, as long as the body component 102 is sized and shaped to fit within a vehicle's cup holder 118. Typically, the body component 102 is approximately 4.25″ high and comprises a diameter of approximately 2.75″ across the bottom and 4.25″ across the top, expanding gradually as it gets to the top 116 but may be any size.

As shown in FIG. 2, the body component 102 contains an absorbent interior lining 104 which completely coats the interior of the body component 200. This absorbent interior lining 104 allows for any kind of liquid to either spill or drip from a beverage 110 to not reach the vehicle 108. This absorbent interior lining 104 is comprised of a synthetic polymer material 202 which can easily soak up liquid and stop it from spreading or splashing. This material 202 lines the entire interior surface of the body component 200, including the wide open top 116. The absorbent interior lining 104 acts to absorb and draw moisture away from the beverage 110 within the body component 102

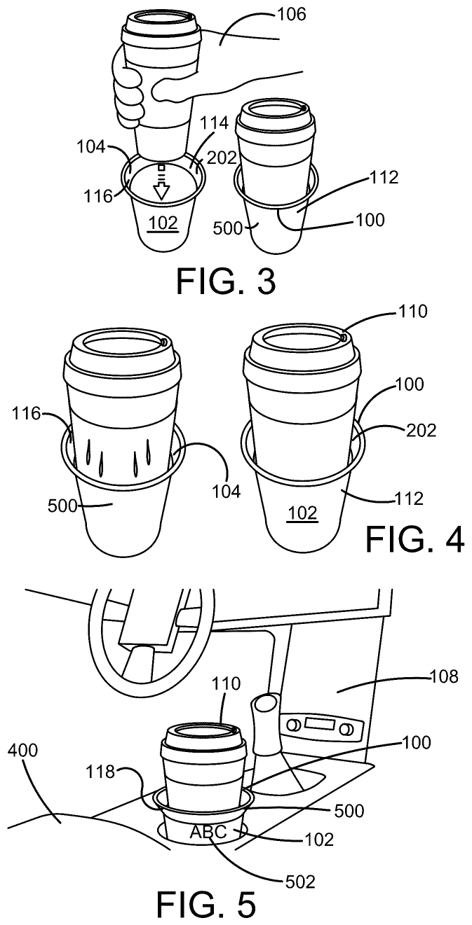

As shown in FIGS. 3-4, the body component 102 comprises a wide open top 116. This wide open top 116 is circular and allows the body component 102 to extend out some and thus have a larger surface area. This wide open top 116 can fit any-sized beverage 110 that would also comfortably fit within a vehicle's cup holder 118 and prevent taller beverages 110 from tipping over. Further, the wide open top 116 allows for any spills coming from the top of a beverage 118 to be caught before splashing anywhere else in the vehicle 108 and causing damage to the interior of the vehicle 108. The body component 102 and the wide open top 116 are one integral piece.

As shown in FIG. 5, the body component 102 is completely disposable and environmentally friendly. In this way, the body component 102 can be thrown out after use and replaced to ensure that it is fresh every time it is in the vehicle 108. This prevents bacteria growth as well as prevents stickiness and bad smells within the vehicle 108. The cup holder device 100 can be recycled as well, which provides a more environmentally friendly alternative.

In yet another embodiment, the cup holder device 100 comprises a plurality of indicia 502. The body component 102 of the device 100 may include advertising, a trademark, or other letters, designs, or characters, printed, painted, stamped, or integrated into the body component 102, or any other indicia 502 as is known in the art. Specifically, any suitable indicia 502 as is known in the art can be included, such as but not limited to, patterns, logos, emblems, images, symbols, designs, letters, words, characters, animals, advertisements, brands, etc., that may or may not be cup holder, beverage, or brand related.

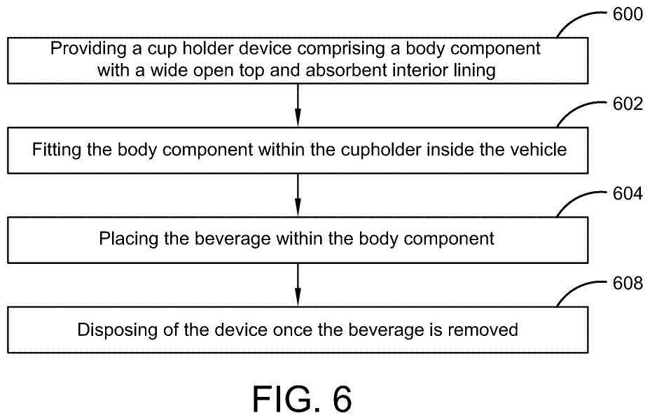

FIG. 6 illustrates a flowchart of the method of protecting a vehicle from spills or drips. The method includes the steps of at 600, providing a cup holder device comprising a body component with a wide open top and absorbent interior lining. Further, the method comprises at 604, fitting the body component within the cupholder inside the vehicle. The method also comprises at 606, placing the beverage within the body component. Finally, the method comprises at 608, disposing of the device once the beverage is removed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “cup holder device”, “cup device”, “vehicle insert device”, and “device” are interchangeable and refer to the cup holder device 100 of the present invention.

Notwithstanding the forgoing, the cup holder device 100 of the present invention can be of any suitable size and configuration as is known in the art without affecting the overall concept of the invention, provided that it accomplishes the above stated objectives. One of ordinary skill in the art will appreciate that the cup holder device 100 as shown in FIGS. 1-6 is for illustrative purposes only, and that many other sizes and shapes of the cup holder device 100 are well within the scope of the present disclosure. Although the dimensions of the cup holder device 100 are important design parameters for user convenience, the cup holder device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cup holder device that provides a user with a cup holder insert for a vehicle, the cup holder device comprising:
a body component; and
an absorbent interior lining;
wherein the absorbent interior lining covers an entire inside of the body component; and
further wherein the absorbent interior lining acts to absorb spills and liquids from a cup positioned within the body component.

2. The cup holder device of claim 1, wherein the body component is configured in a cylindrical shape which is open at the top.

3. The cup holder device of claim 2, wherein the body component comprises an exterior surface, an absorbent interior surface, and a wide open top.

4. The cup holder device of claim 3, wherein the absorbent interior lining is comprised of synthetic polymer material in order to absorb any liquid spilled from a beverage.

5. The cup holder device of claim 4, wherein the body component comprises a wide open top which extends further outward than rest of the body component to catch any spills.

6. The cup holder device of claim 5, wherein the body component and the wide open top is one solid unit.

7. The cup holder device of claim 6, wherein the body component and the wide open top prevents tall drinks from tipping over in a cupholder.

8. The cup holder device of claim 7, wherein the body component is disposable.

9. The cup holder device of claim 8, wherein the body component is reusable.

10. The cup holder device of claim 9, wherein the body component is available in different colors and designs.

11. The cup holder device of claim 10, wherein the body component is approximately 4.25″ high and comprises a diameter of 2.75″ across a bottom and 4.25″ across a top.

12. The cup holder device of claim 11 further comprising a plurality of indicia.

13. A cup holder device that provides a user with an insert to protect their vehicle from spills or drips from a beverage in their cup holder, the cup holder device comprising:
a body component configured in a cylindrical shape with a wide open top, an exterior surface, and an interior surface; and
an absorbent interior lining;
wherein the absorbent interior lining is positioned within the interior surface of the body component;
wherein the absorbent interior lining acts to absorb spills and liquids from a cup positioned within the body component; and
further wherein the wide open top extends outward from the body component to provide a larger surface area in order to catch any spilled liquid.

14. The cup holder device of claim 13, wherein the body component is approximately 4.25″ high and comprises a diameter of 2.75″ across a bottom and 4.25″ across a top.

15. The cup holder device of claim 14, wherein the body component and the wide open top are one integral piece.

16. The cup holder device of claim 15, wherein the absorbent interior lining is comprised of a synthetic polymer material to allow for liquid to be absorbed into the body component.

17. The cup holder device of claim 16, wherein the body component is available in different colors and designs.

18. The cup holder device of claim 17, wherein the body component is disposable.

19. The cup holder device of claim 18, wherein the body component is reuseable.

20. A method of protecting a vehicle from spills, the method comprising the following steps:
providing a cup holder device comprising a body component with a wide open top and absorbent interior lining;
fitting the body component within the cupholder inside the vehicle;
placing the beverage within the body component; and
disposing of the device once the beverage is removed.
